(19) United States
(12) Patent Application Publication
(10) Pub. No.: US 2012/0111274 A1
(43) Pub. Date: May 10, 2012

(54) METHOD OF MILKING A GROUP OF DAIRY ANIMALS BY MEANS OF AN AUTOMATIC MILKING SYSTEM

(75) Inventors: Martinus Petrus KORTEKAAS, LISSE (NL); Pieter Gerlof DE GROOT, GIESSENBURG (NL)

(73) Assignee: LELY PATENT N.V., MAASSLUIS (NL)

(21) Appl. No.: 13/353,343

(22) Filed: Jan. 19, 2012

Related U.S. Application Data
(63) Continuation of application No. PCT/NL2010/000108, filed on Jul. 19, 2010.

(30) Foreign Application Priority Data
Jul. 20, 2009 (NL) 1037142

(51) Int. Cl. A01J 5/007; A01J 5/00

(52) U.S. Cl. 119/14.02; 119/14.08

(57) ABSTRACT

In the method of milking a group of dairy animals by an automatic milking system, the group includes at least two subgroups. The method has a number of steps. In one step, a dairy animal that presents itself for a milking is identified. Subsequently, a decision is taken about whether or not the dairy animal should be milked at that moment. If milking is desirable and the dairy animal belongs to the first subgroup, a teat cleaning treatment is carried out prior to the start of the milking. During the teat cleaning treatment, at least one teat of the dairy animal is cleaned. Upon identification of a dairy animal from the second subgroup, a limitation for a teat cleaning treatment is issued by a control device.

### CROSS REFERENCE TO RELATED APPLICATIONS

This application is a continuation of PCT application number PCT/NL2010/000108 filed on 19 Jul. 2010, which claims priority from Netherlands patent application number 1037142 filed on 20 Jul. 2009. Both applications are hereby incorporated by reference in their entireties.

### BACKGROUND OF THE INVENTION

1. Field of the Invention

The present invention relates to a method of milking a group of dairy animals by means of an automatic milking system, wherein the group comprises at least two subgroups. A first subgroup of dairy animals produces a first type of milk, and a second subgroup of dairy animals produces a second type of milk. The method comprises a number of steps. In one step, a dairy animal that presents itself for a milking is identified. Subsequently, a decision is taken about whether or not the dairy animal should be milked at that moment. If milking is desirable, a teat cleaning treatment is carried out prior to the start of the milking. During the teat cleaning treatment, at least one teat of the dairy animal is cleaned.

2. Description of the Related Art

An automatic milking system is used in the known method. For example, the milking robot is provided with a robot arm for automatically attaching teat cups to an udder of a dairy animal.

The known milking system comprises an at least partially closable space, a so-called milking box, in which the dairy animal can be received. When the dairy animal is received, it is identified by the milking system. Upon identification of the dairy animals, particularities of the individual dairy animal can be processed by the control device during the milking.

Prior to the start of the milking, first a teat cleaning treatment is carried out. At the teat cleaning treatment a cleaning liquid, for example water, is used. When the teats are clean, the teat cups can be attached in order to start the actual milking.

It is a practical problem with the known method for the automatic milking system that the occupancy rate of the milking system is high. In other words, the capacity of the milking system is almost completely utilized. The period of time during which the dairy animal occupies the milking system is often experienced as too long.

NL1016380 describes a cleaning device and method for cleaning the teats of an udder of a dairy animal. The described device is adapted to be used in combination with a milking robot, in which case the milking robot has a robot arm for a mechanical coupling of teat cups to the teats of the udder. The cleaning device is arranged next to the robot arm. Prior to the start of the milking proper of the dairy animal, the teats are cleaned. For this purpose, the cleaning device comprises brushes that can rotate. The teats to be cleaned are drawn between the brushes, so that the teats are cleaned in an extremely efficient manner. If desired, the rollers can be moistened with a cleaning liquid that may consist of water.

WO0067562 discloses a method of cleaning teats, aiming at a reduction of side effects, such as health problems resulting in the occurrence of teat or udder irritations or the development of infections. It is also aimed at a reduction of the cleaning time. In order to reduce the cleaning time, it has been proposed to make the cleaning time dependent on the need for cleaning of an individual animal. Here, the degree of contamination of an individual animal is taken into consideration. Some animals remain cleaner and will thus undergo a shorter teat cleaning treatment. Other animals, on the other hand, often become extra dirty as a result of their behaviour. For these animals it is proposed to insert a longer teat cleaning treatment. It has also been disclosed to make the teat cleaning treatment dependent on the weather conditions or the season. At rainy weather, a longer teat cleaning treatment can be set automatically with the aid of measuring means that are in connection with a computer.

A problem with the known cleaning treatment of the teats is that the teat cleaning treatment still occupies a relatively large amount of time and is, as a result thereof, a limiting factor for the capacity of the milking robot. Despite measures taken to shorten the duration of a teat cleaning treatment, it continues to be desirable to achieve further time savings in the method of cleaning teats.

### BRIEF SUMMARY OF THE INVENTION

The object of the present invention is to obviate at least partially at least one of the above-mentioned drawbacks, or else to provide a usable alternative. The instant invention aims in particular at providing a method by means of which the capacity of the milking system can be increased.

This object is achieved by a method for an automatic milking system. Specifically, a method of milking a group of dairy animals by means of an automatic milking system, wherein the group comprises at least two subgroups, wherein a first subgroup comprises dairy animals that produce a first type of milk, and a second subgroup comprises dairy animals that produce a second type of milk, wherein the method comprises the following steps:

a) identifying a dairy animal that presents itself for a milking;
b) taking a decision about whether the dairy animal that presents itself should be milked;
c) milking the dairy animal if milking is desirable,
characterized in that the method further comprises a step in which, if milking is desirable, upon identification of a dairy animal from the first subgroup a teat cleaning treatment for cleaning at least one teat of the dairy animal is carried out, and wherein, if milking is desirable, upon identification of a dairy animal from the second subgroup a limitation for a teat cleaning treatment to be carried out is issued by a control device.

In the method according to the invention of milking a group of dairy animals by means of an automatic milking system, the group comprises at least two subgroups. The subgroups may be classified on the basis of different types of milk that are given by the dairy animals in question. These different types of milk may, for example, comprise consumption milk, beestings, milk from cows having mastitis, or milk from cows treated with antibiotics. It is usually undesirable to collect these different types in one and the same milk reservoir. Mixing consumption milk with the other types of milk may result in that the consumption milk is no longer fit for consumption. The consumption milk is milk that is fit for human consumption. Milk that should desirably not be mixed with consumption milk will be designated hereinafter as separation milk. By separation milk is meant milk that is separated and is not intended for human consumption. The separation of milk can, for example, take place by discharging milk to a sewer or a separate milk reservoir intended for this purpose. In the method according to the invention, a first subgroup of dairy animals produces a first type of milk, and a second subgroup of dairy animals produces a second type of milk, a separation milk.

The method according to the invention comprises a number of steps. In one step, a dairy animal that presents itself for a milking is identified. Subsequently, a decision is taken about whether or not the dairy animal should be milked at that moment. If milking is desirable and the dairy animal belongs to the first subgroup, a teat cleaning treatment is carried out prior to the start of the milking. During the teat cleaning treatment, at least one teat of the dairy animal is cleaned.

The method according to the invention is characterized in that, upon identification of a dairy animal from the second subgroup, a limitation for a teat cleaning treatment is issued by a control device.

According to the invention, the teat cleaning treatment can be carried out in a limited manner or be omitted completely for the dairy animal from the second subgroup. Normally, the teat cleaning treatment precedes the milk let-down. By cleaning the teats less intensively or not cleaning them at all, a considerable time saving can be achieved at a milking. The time during which a dairy animal occupies the milking system can thus be reduced. The passage time of a dairy animal in the milking system can be reduced. By means of the method according to the invention the capacity of a milking system can be increased considerably.

In a particular embodiment of the method according to the invention, a group of dairy animals is milked by means of an automatic milking system comprising a milking device with a milking box and a robot arm for attaching teat cups, in which case an animal can be admitted, cleaned and milked without human intervention. An example of such an automatic milking system is the known Lely Astronaut, the known Lely Astronaut, which is sold produced/manufactured by Lely Industries N.V., and which is hereby incorporated by reference in its entirety.

In one embodiment of the method according to the invention, the limitation implies that the teat cleaning treatment is omitted or at least moderated for all teats. When, upon identification of the dairy animal, it is established that all teats will produce separation milk, the control device can generate such a limitation for the teat cleaning treatment that no teat is cleaned or that the teats will be cleaned less intensively. The milking system can thus advantageously become available at an earlier point of time for a next dairy animal.

In another embodiment of the method according to the invention, the limitation implies that the teat cleaning treatment is omitted or moderated for at least one teat. With a dairy animal, for example, one of the teats may be known to have an infection, so that the milk from that teat should be separated. In that case, it is advantageous to omit the teat cleaning treatment of the infected teat in question. It can advantageously be prevented that the teat in question will become irritated by an unnecessary cleaning. The risk of health problems can thus be reduced.

In another embodiment of the method according to the invention, the limitation implies that there is carried out a teat cleaning treatment that has been shortened in its duration. The limitation can, for example, imply the generation of a control signal, which is decisive for the duration of the teat cleaning treatment. In one embodiment, in which moving brushes are used for the teat cleaning treatment, the duration of the motion of the brushes can, for example, be shortened. Relative to a completely omitted teat cleaning treatment, it may be advantageous to carry out a shortened teat cleaning treatment because, by the shortened teat cleaning treatment, a stimulating effect is still exercised on the teats, so that the milk let-down is stimulated.

In yet another embodiment of the method according to the invention, the limitation implies that a limited amount of cleaning liquid is used. In one embodiment, the limitation may imply that no cleaning liquid is used for the teat cleaning treatment. In that case, the teat cleaning treatment may solely consist of a mechanical teat cleaning treatment by means of, for example, moving brushes. A saving on cleaning liquids can thus be advantageously achieved, a stimulating effect on the teats still being exerted at the same time, as a result of which the milk let-down is stimulated. In a particular embodiment, it is possible to omit or at least reduce only additions to water, such as cleaning liquid. This can be advantageous, because omitting the additions makes the teat cleaning treatment less harmful to the environment.

In a particular embodiment, the method according to the invention comprises a step in which dairy animals of a subgroup are pre-selected. Carrying out a selection in a step may result in a particular composition of the group. By using the method in a group of dairy animals with a particular composition a considerable time saving can be achieved. The particular composition of the group may imply that the group comprises relatively many dairy animals producing separation milk. In a selected group, the milking cycles can run synchronously to a large extent. In such a group, relatively many dairy animals can simultaneously give beestings that are unfit for consumption and that should not be mixed with the consumption milk.

Another example is a group of dairy animals containing relatively many sick cows that are treated with antibiotics. This group of dairy animals may be selected from a total group and, for example, be separated in order to be subsequently presented collectively to the milking system. The dairy animals from the selected group can be milked one after another, in which case teat cleaning treatments can be omitted or at least be carried out less intensively.

Dairy animals from substantially one subgroup can be allotted to the milking system by selection. Dairy animals from one subgroup can, for example, be refused at first by the milking system, in which case the dairy animals can subsequently be kept apart and be collected until a later point of time.

In yet another embodiment, it is possible to keep a number of dairy animals from a specific subgroup apart and to collect them at the milking system and to have them milked consecutively without allowing dairy animals from the other subgroup to join these collected dairy animals.

Collecting can be carried out manually by a farmer. In such an embodiment, it is possible for the farmer to indicate manually how many dairy animals from the one subgroup should be milked before a dairy animal from the other subgroup can be milked.

It is also possible to carry out the collecting automatically, for example by means of a waiting area that is provided with an automatic access gate. By means of an identification system, it is possible for the access gate to determine the identity of a dairy animal and to establish whether the dairy animal belongs to the subgroup concerned, and whether or not to allow the dairy animal, on the basis thereof, to enter the waiting area. The number of dairy animals present in the waiting area can then be used as the minimum number of dairy animals to be milked from the subgroup concerned.

At the later point of time, the selected dairy animals can subsequently be admitted consecutively to the milking system. By admitting the dairy animals in this manner in groups to the milking system, a considerable saving on the teat cleaning treatments can be obtained. By selecting and admitting in groups the capacity of the milking system can be used more efficiently.

Because, in such particular group compositions, the dairy animals that are admitted to the milking system one after another may belong to the same subgroup, it is possible to achieve a saving on the total cleaning time for a group of dairy animals. Specific actions, such as the rinsing of cleaning brushes, which are necessary for the preparation of a cleaning of a next dairy animal, can be limited or be omitted completely if the next dairy animal belongs to the same subgroup as a previous dairy animal. For this reason it can be advantageous if the method comprises a step in which such a particular group is formed by selection.

### BRIEF DESCRIPTION OF THE DRAWINGS

The features and advantages of the invention will be appreciated upon reference to the following drawings, in which:

FIG. 1 shows a first embodiment of a milking system according to the invention;

FIG. 2 shows a flowchart of an embodiment of the method according to the invention;

FIG. 3 shows a second embodiment according to the invention, and

FIG. 4 shows a third embodiment according to the invention.

### DESCRIPTION OF ILLUSTRATIVE EMBODIMENTS

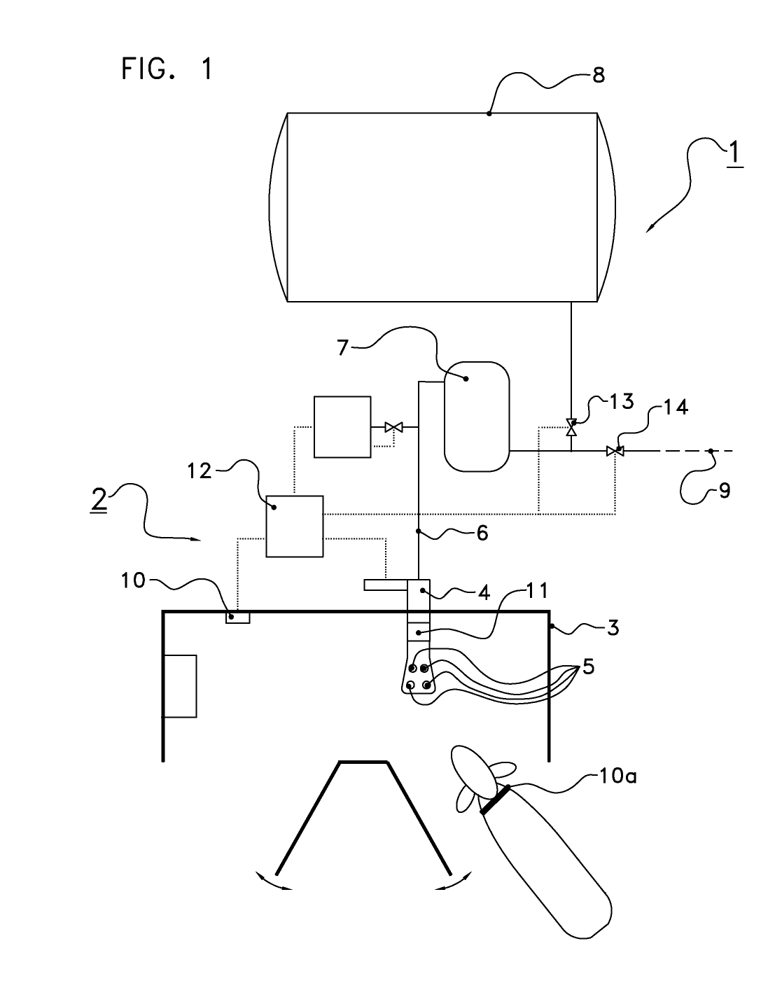

The following is a description of certain embodiments of the invention, given by way of example only and with reference to the drawings. FIG. 1 shows a construction according to the invention, denoted as a whole by reference numeral 1. The construction comprises a milking system 2 with a milking box 3 for receiving a dairy animal, and a milking robot 4 for attaching teat cups 5 to the teats of the dairy animal. The teat cups 5 are each connected to a milk line 6 for leading the milk to a temporary milk reservoir 7, for example a milk jar, for receiving the milk during the milking. After a milking, the milk, in dependence on its type, is discharged from the temporary reservoir 7 to a consumption milk reservoir 8 or another destination 9, for example another milk reservoir or the sewer.

The milking system 2 can be used for milking a group of dairy animals, of which a first subgroup produces consumption milk and a second subgroup produces separation milk. The consumption milk from the first subgroup will be stored in the consumption milk reservoir 8, so that it can be collected at a later point of time by a milk collecting service, while the separation milk is discharged separately to another destination 9, for example stored in a second reservoir or discharged to the sewer. It is possible to discharge different types of separation milk, for example beestings and milk that contains antibiotics, to different destinations. In that case, there are more than two subgroups.

There is provided an identification system 10 that is able to identify a dairy animal present in the milking box, for example by means of a transponder 10a attached to a collar of the dairy animal.

In the embodiment of FIG. 1 there is provided a control device 12 for controlling the milking system 2 to milk a dairy animal present in the milking box 3. The control device 12 is further configured to control valves 13 and 14 disposed in the milk line 6, by means of which the milk can be led from the temporary milk reservoir 7 to the consumption milk reservoir 8 or the other destination 9.

The control device 12 is also provided for putting, if required, a teat cleaning device 11 into operation. According to the invention, the control device 12 is configured to limit or to omit completely the cleaning of at least one teat of a dairy animal from the second subgroup. The limitation preferably relates to the teat cleaning treatment prior to the milk let-down.

In one embodiment, the teat cleaning device can be designed so as to have at least two cleaning brushes. The cleaning brushes can be arranged rotatably. Preferably, an assembly of two cleaning brushes has a pair of axes of rotation located substantially parallel. Preferably, the cleaning brushes rotate in opposite directions during operation. Preferably, the teat cleaning device is further provided with a cleaning liquid supplying unit. By means of this, water with an additive can, for example, be supplied as a cleaning liquid. Preferably, the cleaning liquid supplying unit is configured to supply a cleaning liquid over the cleaning brushes. For this purpose, the cleaning liquid supplying unit can be provided with spray nozzles.

In one embodiment of the teat cleaning device, there may be provided a cleaning cup for cleaning a teat. The cleaning cup can receive a teat in a cup space. The teat can be cleaned with the aid of a cleaning liquid supplied to the cleaning cup.

If desired, during a teat cleaning treatment air can be supplied, for example for drying a teat. There may be provided heating means for heating air and/or cleaning liquid.

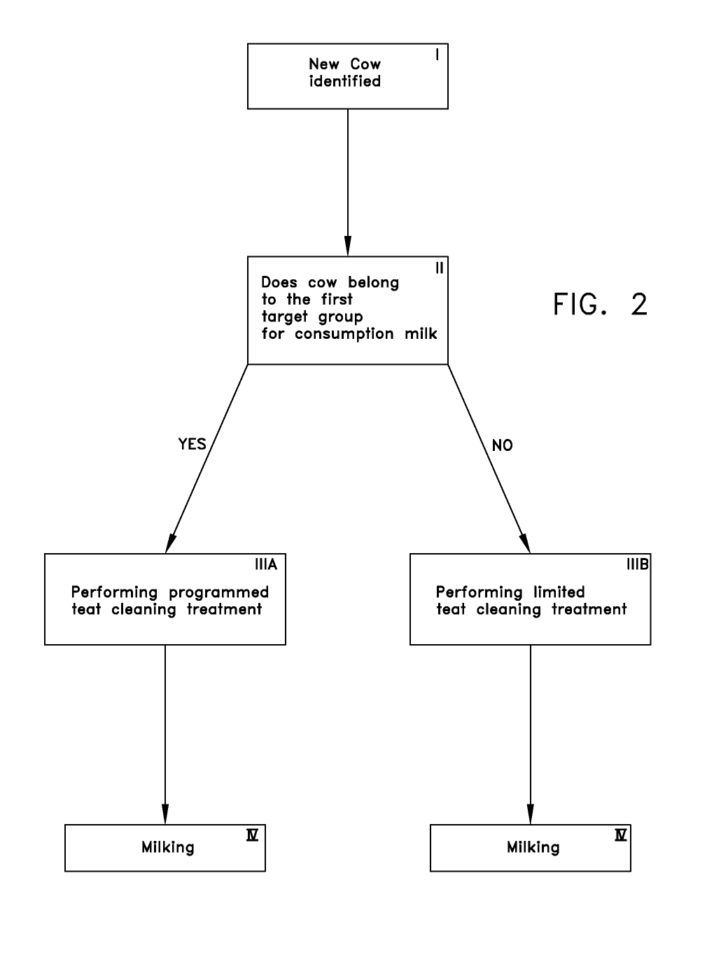

FIG. 2 shows in a flowchart with four steps I, II, III and IV how the control device 12 can be applied when milking a group of dairy animals. The group of dairy animals is divided into a first subgroup that produces consumption milk and a second subgroup that produces separation milk. In a first step I, a dairy animal is identified by means of the identification system 10 when it enters the milking box 3. On the basis of this identification, the control device can determine to which subgroup the dairy animal belongs. In a second step II, it is determined whether the dairy animal belongs to the first subgroup A for producing consumption milk.

If the identified dairy animal belongs to the first subgroup, the dairy animal can immediately undergo a programmed teat cleaning treatment. This takes place in step IIIA. The programmed teat cleaning treatment can be a standard treatment that is programmed for all dairy animals. The programmed teat cleaning treatment can also relate to an individual teat cleaning treatment programmed in dependence on the dairy animal. In the teat cleaning treatment attuned to the individual dairy animal, it is possible, for example, to take the sensitivity of contamination of the dairy animal in question into account. By their behaviour or physical properties, such as low positioned udders, it is possible for dairy animals to become contaminated to a greater or lesser extent. In the programmed teat cleaning treatment, this may have been taken into account by prescribing for one dairy animal a more intensive teat cleaning treatment than for another dairy animal. Weather conditions may also have been processed in the programmed teat cleaning treatment. The teat cleaning treatment can, for example, be carried out more intensively under wet conditions.

If the identified dairy animal belongs to the second subgroup B, according to the invention a limited teat cleaning treatment is carried out or the teat cleaning treatment is completely omitted. This takes place in step IIIB. The dairy animal is milked in a following step IV. In the case of separation milk, the control device 12 will control the valves 13, 14 to lead the separation milk after the milking to another destination 9 than the consumption milk reservoir 8.

Furthermore, before, during or after the milking of the new cow from the first subgroup, the valves 13, 14 will be controlled by the control device in order to lead the consumption milk of the new cow, after the milking, from the temporary milk reservoir 7 to the consumption milk reservoir 8.

During or after the milking it is further possible to check whether the milk of the new cow is indeed fit for consumption. If this is not the case, because the dairy animal has, for example, become ill, it is still possible to lead the milk from the temporary milk reservoir 7 to another destination 9.

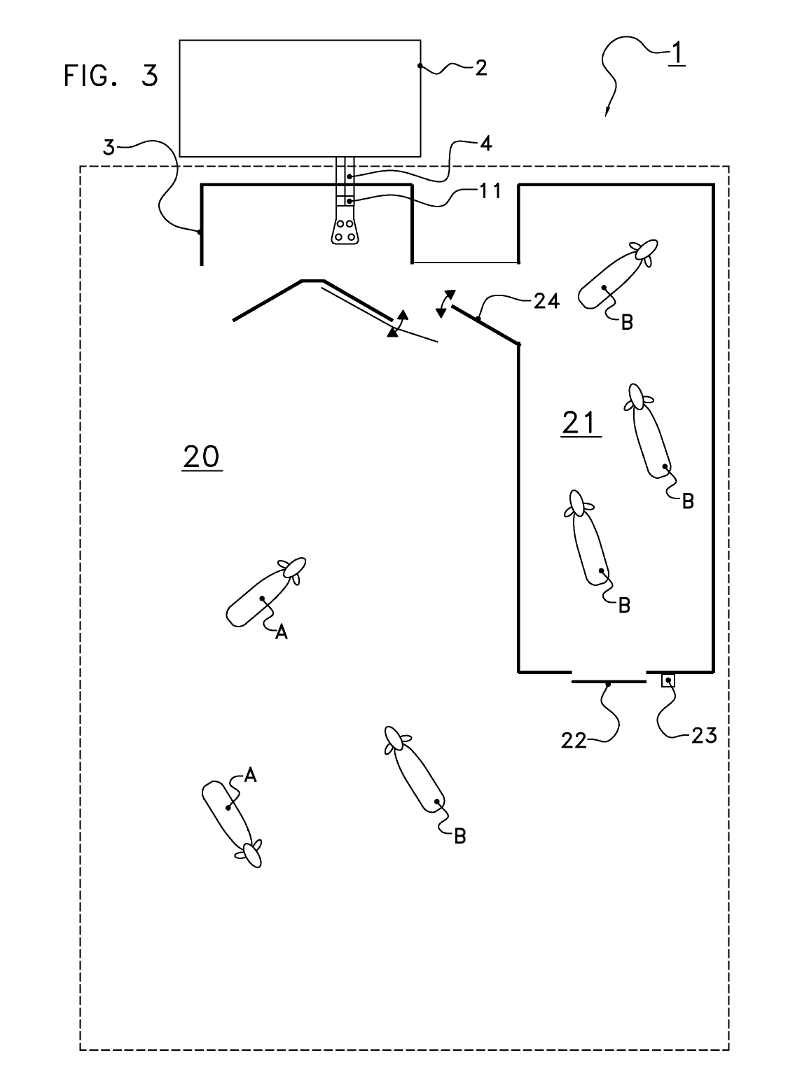

FIG. 3 shows an embodiment of a construction 1 comprising a milking system 2 with a milking box 3 and a milking robot 4. For the rest, the milking system 2 can be designed in accordance with the milking system 2 of FIG. 1 and is not shown in further detail in FIG. 3. The milking box 3 is arranged in a closed area 20, for example a pasture or a stable, in which a group of dairy animals A, B is present. The group comprises two subgroups with dairy animals A from the first subgroup that produce consumption milk and dairy animals B from a second subgroup that produce separation milk.

The construction 1 is provided with a waiting area 21 for collecting a number of dairy animals belonging to a specific subgroup. The drawing shows that dairy animals B from the second subgroup have been collected in the waiting area 21. This collecting may have been carried out manually by a farmer. It is also possible that there is provided an automatic access gate 22 for the waiting area, which access gate only admits dairy animals from the relevant subgroup. For this purpose, the access gate 22 may be provided with an identification system 23 that is able to determine to which subgroup a dairy animal belongs and to decide, in dependence thereof, to open or not to open the access gate.

If a number of dairy animals from a specific subgroup have been collected in the waiting area 21, these dairy animals can be milked consecutively in a simple manner.

In order to milk the dairy animals in the waiting area 21 consecutively, there is provided an admission system 24 that directly admits dairy animals from the waiting area 21 or selectively from the closed area 20. The admission system 24 may be designed as an automatic system but may alternatively also be manually operable. If desired, the admission system can be provided with an identification system for determining the identity of dairy animals that report at the admission system 24 from the waiting area 21 or directly from the closed area 20.

The number of dairy animals present in the waiting area 21 can be used as the minimum number of dairy animals from this subgroup to be milked consecutively. This can be made manually by the farmer, in particular if the farmer has also collected himself the dairy animals B in the waiting area 21. It is also possible that, on the basis of information from the automatic access gate 22 and/or the automatic admission system 24, the minimum number of dairy animals is determined.

For example, if five dairy animals B have been admitted by the automatic access gate 23 to the waiting area 21, the automatic access gate 23 can transmit this information to the control device 12 in order to milk consecutively at least five dairy animals B from the waiting area 21. In this case, the automatic admission system 24 can be controlled to admit, during the milking of these dairy animals B from the waiting area 21, only dairy animals B from the waiting area 21 to the milking box 3. After the milking of the desired number of dairy animals B from the waiting area 21 the milking system 2 can be rinsed, possibly after identification of a next dairy animal.

When during the milking of the dairy animals B from the waiting area 21 new dairy animals B are admitted, the minimum number of dairy animals to be milked can be raised accordingly.

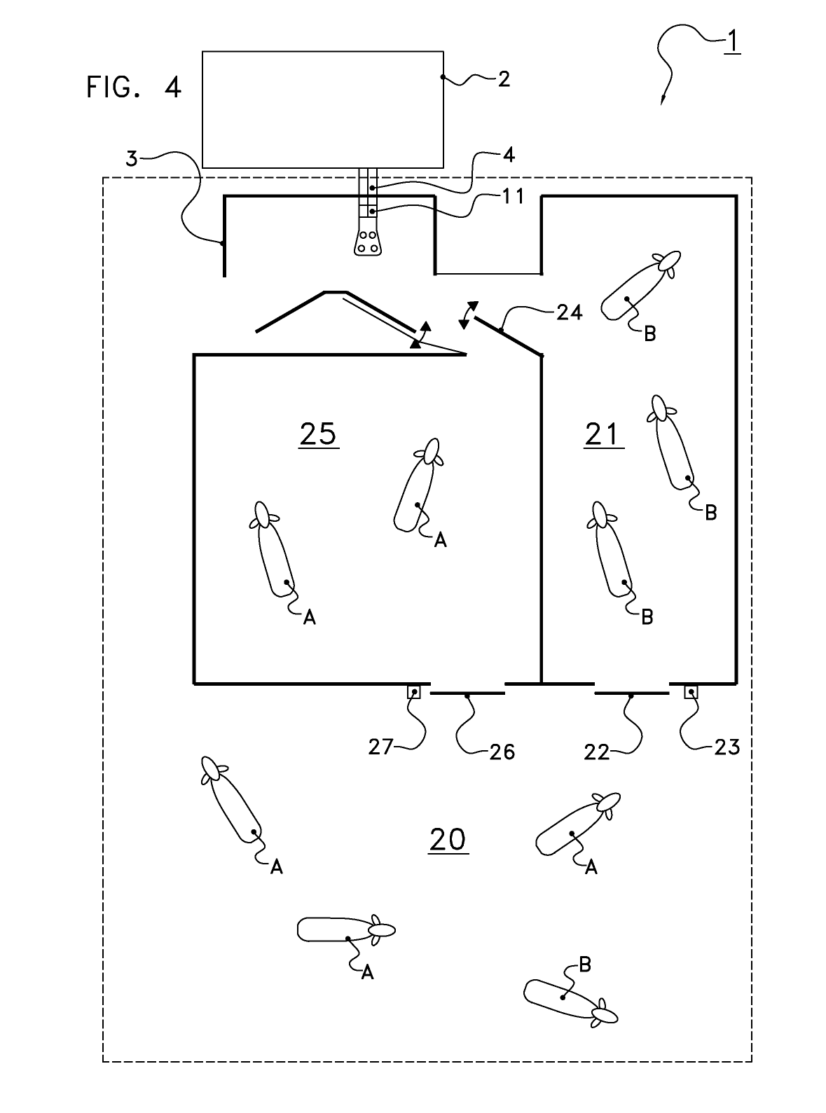

FIG. 4 shows an alternative embodiment of the construction of FIG. 3. In this construction, there is provided a second waiting area 25 for collecting dairy animals from a specific subgroup. In this embodiment, both dairy animals A from the first subgroup and dairy animals B from the second subgroup can be collected in the waiting areas 25, 21, respectively.

Both the waiting area 21 and the waiting area 25 are provided with an automatic access gate 22, 26 with an identification system 23, 27. The dairy animals A, B are thus collected automatically in the respective waiting area 21, 25. Alternatively, this can also be carried out manually.

On the basis of the numbers of dairy animals present in the waiting areas 21, 25, the number of dairy animals to be milked consecutively from the first or the second subgroup can be determined. On the basis of these data, the automatic admission system 24 can admit selectively dairy animals from one of the two waiting areas 21, 25 to the milking box 3. In this manner, the efficiency of the use of the milking system 2 can be increased further.

There are thus provided according to the invention a method and a construction in which for a subgroup a limited teat cleaning treatment is carried out, by means of which considerable time savings can be achieved. As a result thereof, the capacity of an automatic milking system can advantageously be increased. Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method of milking a group of dairy animals by an automatic milking system, wherein the group comprises at least two subgroups, wherein a first subgroup comprises dairy animals that produce a first type of milk, and a second subgroup comprises dairy animals that produce a second type of milk, wherein the method comprises the following steps:
a) identifying a dairy animal that presents itself for a milking;
b) taking a decision about whether the dairy animal that presents itself should be milked;
c) milking the dairy animal if the decision is that the dairy animal should be milked,
wherein the method further comprises a step in which, if milking is desirable, upon identification of a dairy animal from the first subgroup a teat cleaning treatment for cleaning at least one teat of the dairy animal is carried out, and wherein, if milking is desirable, upon identification of a dairy animal from the second subgroup a limitation for a teat cleaning treatment to be carried out is issued by a control device.

2. The method according to claim 1, wherein the limitation comprises an omission of the teat cleaning treatment for all teats.

3. The method according to claim 1, wherein the first type of milk is consumption milk and the second type of milk is separation milk.

4. The method according to claim 1, wherein the limitation comprises an omission or moderation of the teat cleaning treatment for at least one teat.

5. The method according to claim 1, wherein the limitation comprises a teat cleaning treatment that has been shortened in its duration.

6. The method according to claim 1, wherein the limitation comprises a reduction of the total amount of cleaning liquid used.

7. The method according to claim 1, wherein the limitation comprises a reduction of an ingredient of the cleaning liquid.

8. The method according to claim 1, wherein the method comprises a step in which dairy animals are selected on the basis of a type of milk to be given and are kept apart prior to the start of a milking in groups.

9. The method according to claim 8, wherein at the milking in groups a teat cleaning treatment is limited.

10. A construction for milking a group of dairy animals, wherein the group comprises at least two subgroups, wherein a first subgroup comprises dairy animals that produce a first type of milk, and a second subgroup comprises dairy animals that produce a second type of milk, comprising:
a milking system for milking the dairy animal,
an identification system for identifying a dairy animal that presents itself for a milking,
a teat cleaning device for cleaning at least one teat, and
a control device, wherein the control device is configured to:
take a decision about whether the dairy animal that presents itself should be milked,
if it is decided that the dairy animal should be milked, then the control device controls the milking system for milking the dairy animal, and
put the teat cleaning device into operation, for cleaning a teat of a dairy animal from the first subgroup,
wherein the control device, upon identification of a dairy animal from the second subgroup, is configured to limit the action of the teat cleaning device.

11. The construction according to claim 10, wherein the construction comprises at least one waiting area for collecting dairy animals from one of the two subgroups.

12. The construction according to claim 10, wherein the milking system comprises two waiting areas, wherein dairy animals from the first subgroup are collected in a first waiting area and dairy animals from the second subgroup are collected in a second waiting area, and wherein, after a dairy animal from one of the waiting areas has been milked, only dairy animals from the same one waiting area are admitted until a minimum number of dairy animals from said one waiting area has been milked or until no more dairy animals are present in said waiting area.

13. The construction according to claim 10, wherein the construction has an automatic admission system for selectively admitting dairy animals from at least one of: the waiting area, the second waiting area, and another area to the milking system.

14. The construction according to claim 13, wherein at least one of the waiting area and the second waiting area comprises an automatic access gate for admitting dairy animals to the waiting area, the second waiting area, respectively.

15. A method of milking a group of dairy animals by an automatic milking system, wherein the group comprises at least two subgroups, wherein a first subgroup comprises dairy animals that produce a first type of milk, and a second subgroup comprises dairy animals that produce a second type of milk, wherein the method comprises the following steps:
a) identifying a dairy animal that presents itself for a milking;
b) transmitting that identification to a control device, wherein based on this identification, the control devices determines whether the dairy animal that presents itself should be milked;
and if it has been determined that the dairy animal should be milked:
c) if the control device determines the dairy animal is from the first subgroup a teat cleaning treatment for cleaning at least one teat of the dairy animal is carried out, and wherein, if the control device determines that the dairy animal is from the second subgroup and the dairy animal should be milked, a limitation for the teat cleaning treatment is carried out; and
d) milking the identified dairy animal.
